(19) United States
(12) Patent Application Publication
(10) Pub. No.: US 2015/0360914 A1
(43) Pub. Date: Dec. 17, 2015

(54) MODULAR CONTAINER LIFT SPREADER

(71) Applicant: Tandemloc, Inc., Havelock, NC (US)

(72) Inventor: Jon M. Lamrouex, New Bern, NC (US)

(73) Assignee: Tandemloc, Inc., Havelock, NC (US)

(21) Appl. No.: 14/734,209

(22) Filed: Jun. 9, 2015

Related U.S. Application Data
(60) Provisional application No. 62/011,186, filed on Jun. 12, 2014.

(51) Int. Cl. B66C 1/10

(52) U.S. Cl. CPC B66C 1/101

(57) ABSTRACT

A modular container lift spreader system is disclosed. The modular container lift spreader system may include a modular frame, including a first frame portion and a second frame portion; extension beams configured to be disposed between ends of the first frame portion and the second frame portion, wherein the two or more extension beams are configured to connect the first frame portion to the second frame portion in a non-permanent manner; and connector plates fixed to the ends of the first frame portion and second frame portion and ends of the two or more extension beams, wherein the connector plates are configured to connect to one another in a non-permanent manner. A method of assembling a modular container lift spreader is also disclosed.

### TECHNICAL FIELD

The invention is directed to a container lift spreader. Specifically, the invention is related to a modular container lift spreader system.

### BACKGROUND

Conventional container lift spreaders for cargo containers are manufactured to their specific size requirements, e.g., 20 ft. and/or 40 ft. and delivered preassembled. Because of their size when assembled, conventional container lift spreaders often cannot be shipped in a standard box truck or a cargo container, but must rather be shipped on a flatbed truck or be specially accommodated as cargo for overseas shipping, both of which make transporting/shipping conventional assembled container lift spreaders very expensive. Further, as different size container lift spreaders may be required to accommodate the loading and/or loading of various size cargo containers, facilities may be required to store multiple sizes of container lift spreaders, e.g., 20 ft. and 40 ft. This is disadvantages as storage space can be limited and expensive to maintain.

Thus, there is a need for a modular container lift spreader that is assemblable in the field and when dissembled is shippable in a standard ocean going shipping container or over-the-road box truck or standard semi-truck within a fully enclosed trailer. There is also a need for a modular container lift spreader that is capable of using interchangeable components, to allow for the capability of assembling, in the field, varies size container lift spreader, e.g., 20 ft. and 40 ft. versions, without the need to store multiple sizes of fully assembled container lift spreaders

### SUMMARY

In one embodiment, a modular container lift spreader system is provided. The modular container lift spreader system may include a modular frame, including a first frame portion and a second frame portion; extension beams configured to be disposed between ends of the first frame portion and the second frame portion, wherein the two or more extension beams are configured to connect the first frame portion to the second frame portion in a non-permanent manner; and connector plates fixed to the ends of the first frame portion and second frame portion and ends of the two or more extension beams, wherein the connector plates are configured to connect to one another in a non-permanent manner. The first frame portion and second frame portion each may include a first side beam and a second side beam attached to opposing end portions of a respective end beam. The first side beam of each of the first frame portion may be substantially parallel relative to its respective second side beam, and wherein each of the first and second side beams may be substantially perpendicular relative to their respective end beams. The first and second side beams may be in a range of about 70 inches to about 80 inches in length. The two or more extension beams may be in a range of about 70 inches to about 80 inches in length. The modular container lift spreader system may further include at least one cross beam disposed between each of the first and second side beams of the first frame portion and/or second frame portion. The at least one cross beam may be substantially perpendicular relative to the first and second side beams of the first frame portion and/or second frame portion. The modular container lift spreader system may further include container connector mechanisms disposed at each corner of the modular frame for engaging connection fittings of a container to be moved. The container connector mechanisms may include twist lock bayonets. The modular container lift spreader system may further include a gear box and a drive linkage, wherein the gear box may be operably connected to the container connector mechanisms by the drive linkage. The gear box may be mounted to a cross beam disposed between a first side beam and a second side beam of one of the first frame portion or second frame portion. The gear box and drive linkage may be configured to simultaneously actuate all the container connector mechanisms between a locked and unlocked position. The modular container lift spreader system may further include one or more drive linkage extensions, wherein the drive linkage extensions may be configured to operably attach to an end of a drive linkage and/or between two drive linkages to extend the length of the drive linkage. The gear box may include a lift arm, wherein the lift arm is configured to drive the gear box. The lift arm may be operably connected to an actuator sling, wherein the actuator sling may be configured such that lowering and raising of the actuator sling actuates the arm of the gear box to simultaneously operate the container connector mechanisms between locked and unlocked positions. The actuator sling may be further operably attached to a lift sling, wherein the lift sling may include one or more cables for attaching the modular frame to a lifting mechanism. The extension beams may include one or more frame extension sections, and wherein the one or more frame extension sections may include at least two parallel side beams spaced apart from one another by one or more cross support beams.

In another embodiment, a method of assembling a modular container lift spreader is provided. The method may include providing a modular container lift spreader system. The modular container lift spreader system may include a modular frame, comprising a first frame portion and a second frame portion; extension beams configured to be disposed between ends of the first frame portion and the second frame portion, wherein the two or more extension beams are configured to connect the first frame portion to the second frame portion in a non-permanent manner; and connector plates fixed to the ends of the first frame portion and second frame portion and ends of the two or more extension beams, wherein the connector plates are configured to connect to one another in a non-permanent manner. The method may further include connecting extension beams between ends of the first frame portion and the second frame portion via the connector plates to achieve a desired length of the modular container lift spreader. The modular container lift spreader system may further include a gear box and a drive linkage, wherein the gear box may be operably connected to container connector mechanisms by the drive linkage, and wherein the container connector mechanisms may be configured for engaging connection fittings of a container to be moved. The method may further include connecting one or more drive linkage extensions to the drive linkage based on the desired length of the modular container lift spreader, and wherein the drive linkage extensions may be configured to operably attach to an end of a drive linkage and/or between two drive linkages to extend the length thereof. The extension beams may include one or more frame extension sections, and wherein the one or more frame extension sections may include at least two parallel side beams spaced apart from one another by one or more cross support beams.

### BRIEF DESCRIPTION OF THE DRAWINGS

Having thus described the presently disclosed subject matter in general terms, reference will now be made to the accompanying Drawings, which are not necessarily drawn to scale, and wherein:

FIGS. 1A and 1B illustrate perspective views of conventional container lift spreaders;

FIG. 2A illustrates a perspective view of an assembled modular container lift spreader in accordance with an embodiment of the invention;

FIG. 2B illustrates a top view of an assembled modular container lift spreader in accordance with an embodiment of the invention;

FIG. 2C illustrates a side view of an assembled modular container lift spreader in accordance with an embodiment of the invention;

FIG. 2D illustrates an end view of an assembled modular container lift spreader in accordance with an embodiment of the invention;

FIG. 3A illustrates an perspective view of a frame portion of a disassembled modular container lift spreader in accordance with an embodiment of the invention;

FIG. 3B illustrates a top view of a frame portion of a disassembled modular container lift spreader in accordance with an embodiment of the invention;

FIG. 3C illustrates a side view of a frame portion of a disassembled modular container lift spreader in accordance with an embodiment of the invention;

FIG. 3D illustrates an end view of a frame portion of a disassembled modular container lift spreader in accordance with an embodiment of the invention;

FIG. 4A illustrates an perspective view of an extension beam portion of a disassembled modular container lift spreader in accordance with an embodiment of the invention;

FIG. 4B illustrates a top view of an extension beam portion of a disassembled modular container lift spreader in accordance with an embodiment of the invention;

FIG. 4C illustrates a side view of an extension beam portion of a disassembled modular container lift spreader in accordance with an embodiment of the invention;

FIG. 4D illustrates an end view of an extension beam portion of a disassembled modular container lift spreader in accordance with an embodiment of the invention; and

FIG. 5 illustrates a perspective view of a frame extension portion of a disassembled modular container lift spreader in accordance with an embodiment of the invention.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The invention is directed to a modular container lift spreader system for use in lifting and/or manipulating cargo containers, such as, intermodal containers, freight containers, ISO containers, shipping containers, hi-cube containers, box containers, sea containers, and the like. The modular container lift spreader system is capable of being stored and transported in a disassembled state and assembled in the field, and also capable of being assembled into container lift spreaders of varying sizes, e.g., 20 ft. and 40 ft.

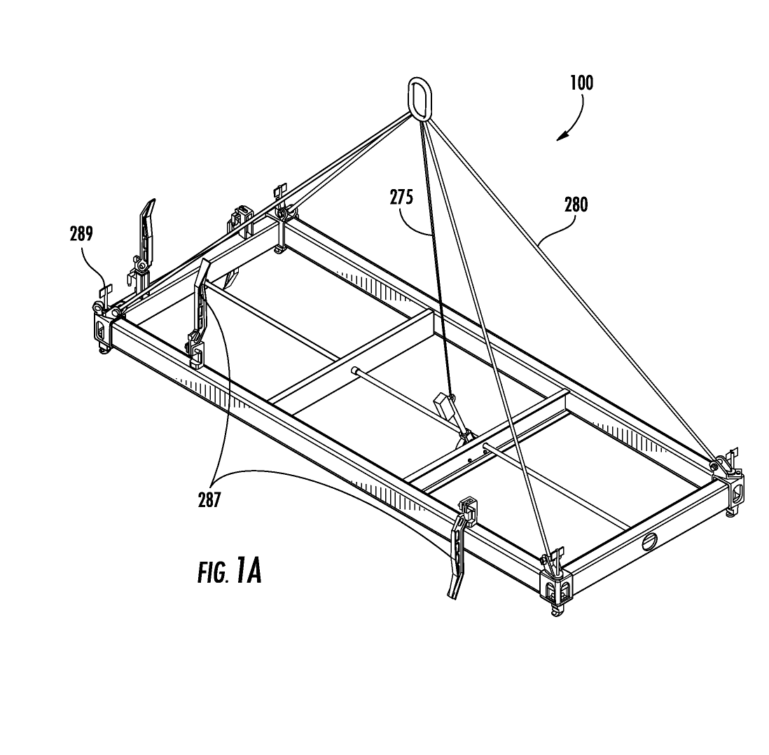

FIGS. 1A-1B are illustrative of a conventional container lift spreader 100, which are manufactured as a primarily unitary structure to be of a specific non-adjustable size, such as a twenty foot (20′) container lift spreader (as shown in FIG. 1A) or, for example, as a forty foot (40′) container lift spreader (as shown in FIG. 1B). Because conventional lift spreaders are non-modular, i.e., substantially a single manufactured unit manufactured to a specific size requirements (20′, 40′, etc.), they in turn must be delivered in their fully assembled state, which makes the conventional non-modular lift spreaders very difficult and costly to transport/ship. Further, as these conventional non-modular container lift spreaders are built to specific size requirements, and are non-adjustable, if a site needs container lift spreaders to accommodate different size cargo containers (20′, 40′, etc.), then the site would be required to store multiple sizes of fully assembled container lift spreaders, requiring valuable storage space and increased costs.

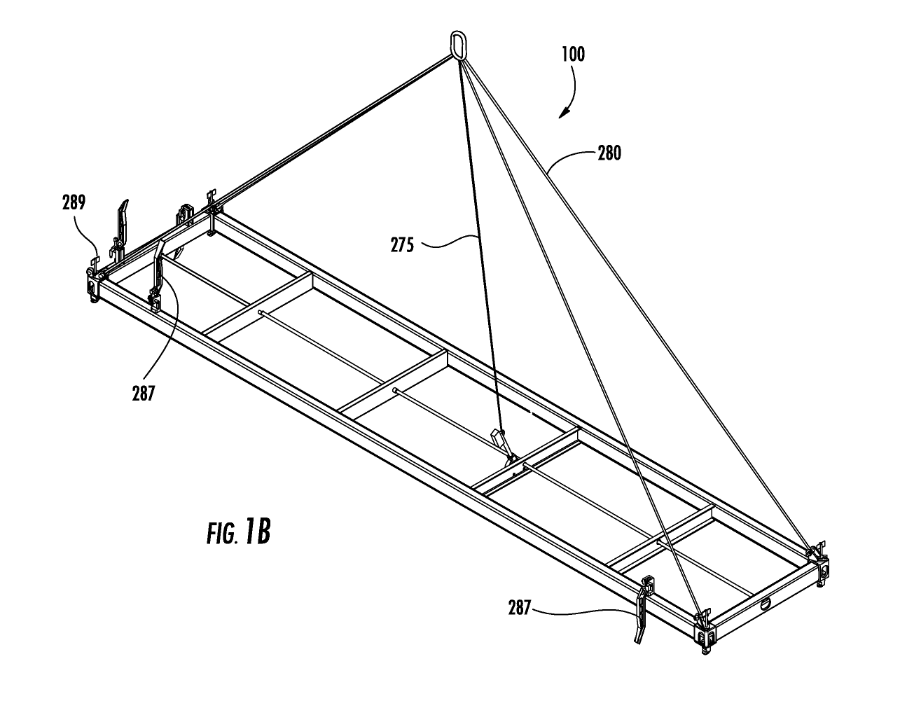

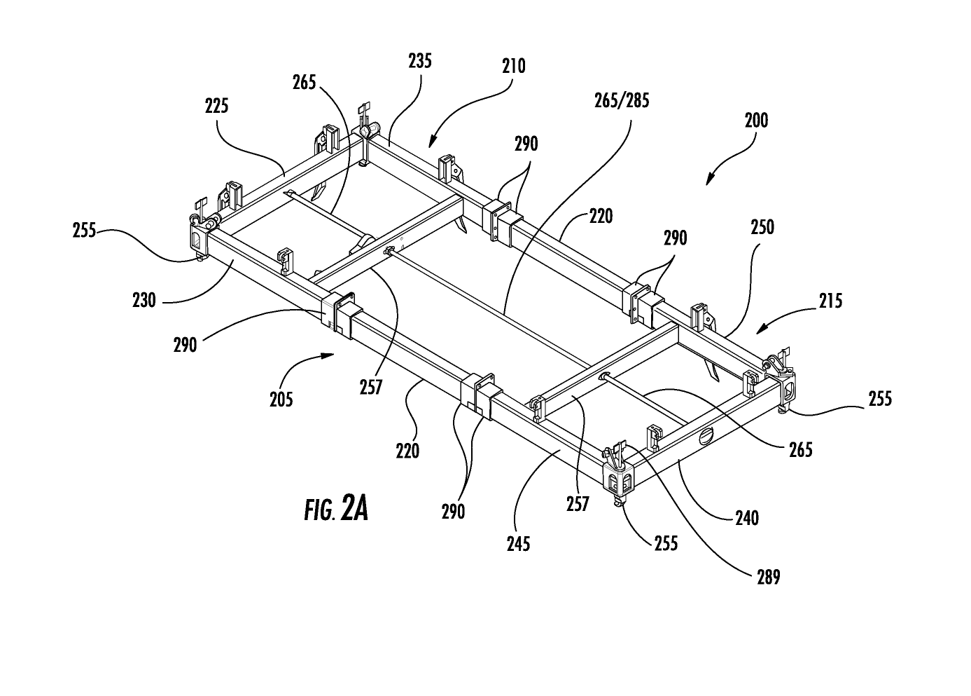

FIGS. 2-5 are illustrative of embodiments of a modular container lift spreader system consistent with the invention disclosed herein.

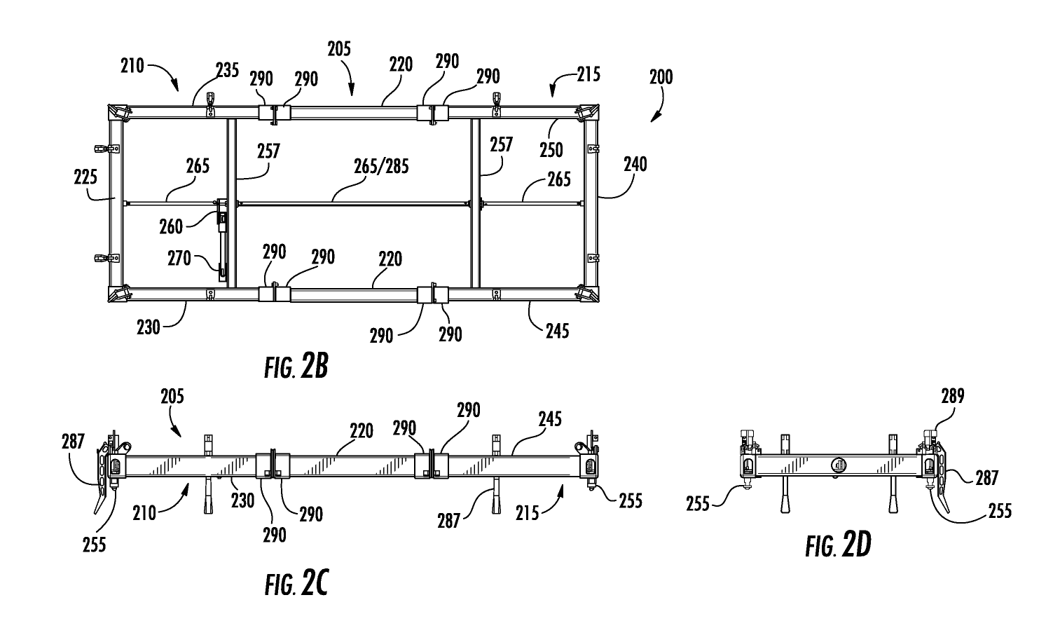

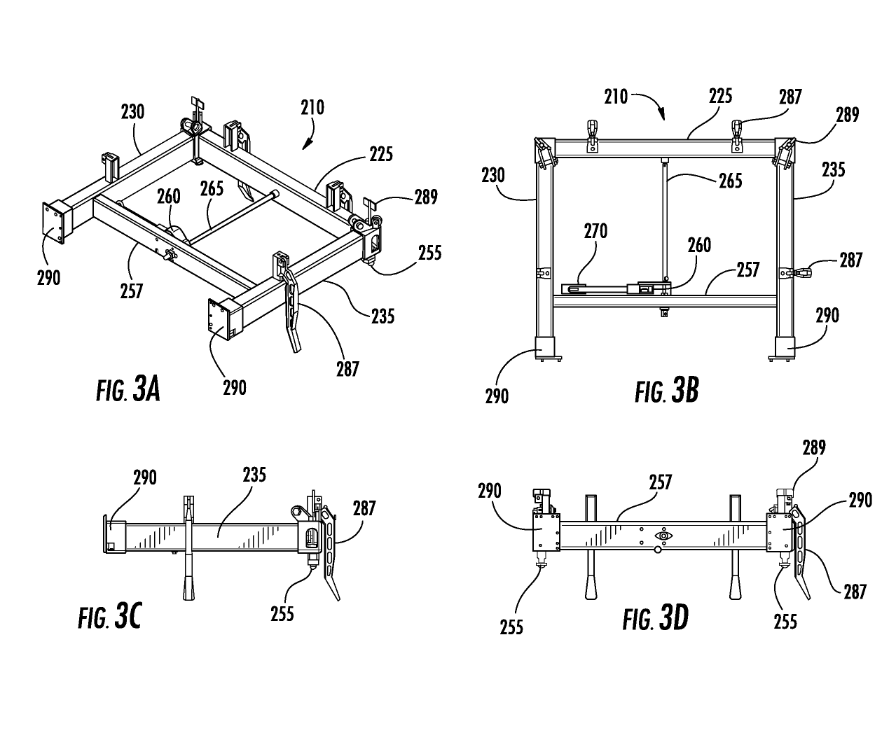

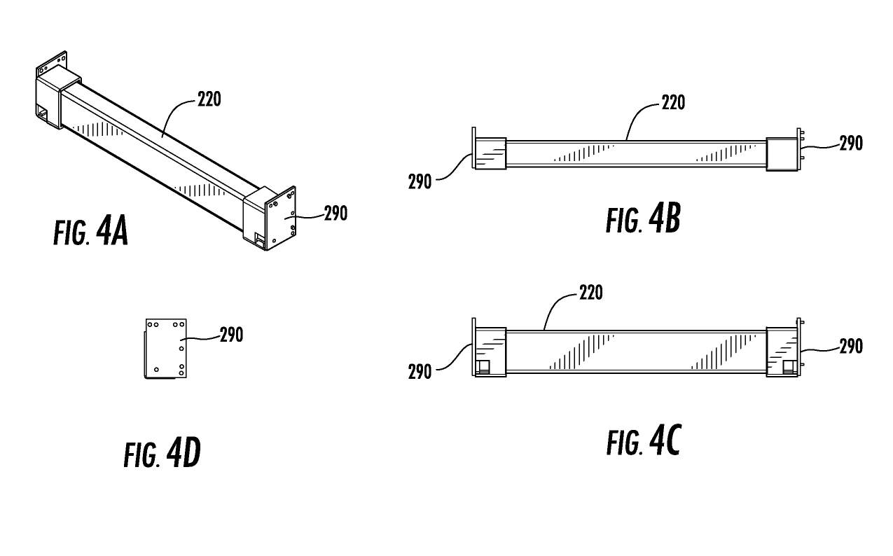

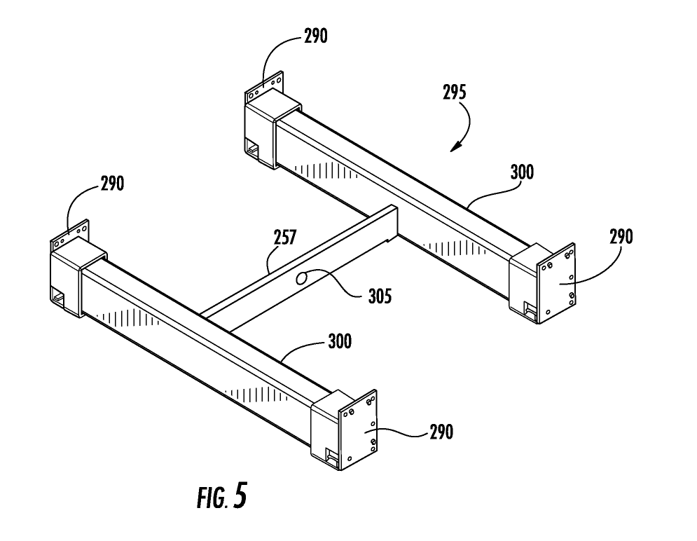

FIGS. 2A-D illustrate a modular container lift spreader 200 in an assembled state. Modular container lift spreader 200 in an assembled state may include a modular frame 205. Modular frame 205 may be substantially rectangular (or substantially square) in general shape. Modular frame 205 and the components thereof may be made of steel or other suitably strong material for supporting and lifting of containers, such as cargo containers. Modular frame 205 may include a first frame portion 210 and a second frame portion 215 (shown in more detail in FIG. 3), and two or more extension beams 220 (shown in more detail in FIG. 4), wherein the two or more extension beams 220 may be disposed lengthwise and spaced between first frame portion 210 and second frame portion 215 to extend the overall length of modular frame 205.

First frame portion 210 may include an end beam 225, a first side beam 230 and a second side beam 235. First side beam 230 and a second side beam 235 are attached to opposing end portions of end beam 225 in a substantially perpendicular orientation thereto. First side beam 230 and second side beam 235 extend in the same direction from end beam 225 and are substantially parallel with one another. Second frame portion 215 may include an end beam 240, a first side beam 245, and a second side beam 250. First side beam 230 and second side beam 235 are attached to opposing end portions of end beam 240 in a substantially perpendicular orientation thereto. First side beam 245 and second side beam 250 extend in the same direction from end beam 240 and are substantially parallel with one another. End beam 225 and end beam 240 may have a substantially rectangular, square, I, circular, or other suitably shaped cross section, and in one example, may be in the range of about 6 inches to about 8 inches in width and about 75 inches to about 85 inches in length. First side beam 230, second side beam 235, first side beam 245, and second side beam 250 may have a substantially rectangular, square, I, circular, or other suitably shaped cross section, and in one example, may be in the range of about 6 inches to about 8 inches in width and about 70 inches to about 80 inches in length.

Modular frame 205 may further include one or more cross support beams 257, wherein one or more of cross support beams 257 may span from first side beam 230 to second side beam 235 of first frame portion 210 and/or from first side beam 245 to second side beam 250 of second frame portion 215. Each end of cross support beams 257 may be permanently (welded or the like) or removably (bolts, pins, clips, clamps, or the like) attached to their respective first side beam 230, second side beam 235, first side beam 245, and/or second side beam 250. In an embodiment cross support beams 257 are orientated substantially perpendicular to first side beam 230 and second side beam 235 and/or first side beam 245 and second side beam 250, and substantially parallel with end beam 225 and/or 240. Cross support beams 257 may have a substantially rectangular, square, I, or circular cross section, and in one example, may be in the range of about 4 inches to about 8 inches in width and about 75 inches to about 85 inches in length.

Modular container lift spreader 200 may further include container connector mechanisms 255, such as twist lock bayonets, positioned at each corner of modular frame 205, for engaging a respective container connection point, for example a top aperture in a standard ISO container (e.g., ISO 1161 corner fitting), on a container to be lifted. Modular container lift spreader system 200 may also further include a gear box 260 operably connected to a drive linkage 265. In one example, gear box 260 may be mounted to one of cross support beams 257. Drive linkage 265 is further operably connected to the container connector mechanisms 255 to simultaneously engage and disengage the container connector mechanisms 255 with the container connection points on the container to be lifted. Gear box 260 may include an arm 270 operably attached to an actuator sling 275 (shown in FIGS. 1A and 1B). Arm 270 may be a weighted arm. Actuator sling 275 may further be attached to a lift sling 280 (also shown in FIGS. 1A and 1B). In one example, lowering and raising of the lift sling 280 (such as by a crane) actuates arm 270 of gear box 260 (through attachment to actuator sling 275), such that the container connector mechanisms 255 are all in an unlocked position when the modular container lift spreader 200 is first lifted and then are in the locked position when lowered and lifted again, alternating between unlocked and locked with each cycle.

Modular container lift spreader 200 may further include one or more drive linkage extensions 285 to extend the length of drive linkage 265, such that drive linkage 265 is substantially the length of modular frame 205 (from end beam 225 to end beam 240) to accommodate for assembly of different size modular container lift spreaders 200. One or more drive linkage extensions 285 may be connected to an end of drive linkage 265, or alternatively may be connected between two drive linkages 265 to extend it overall length to match the desired modular container lift spreader 200 size.

Modular container lift spreader 200 may further include one or more guides 287 (e.g., flipper guides), for guiding the modular container lift spreader 200 into alignment with the container to be moved, such that container connector mechanisms 255 align with their respective container connection points. In one example, modular container lift spreader 200 may include four (4) guides 287.

Modular container lift spreader 200 may further include indicator flags 289 located at each corner of modular frame 205, wherein indicator flags 289 are operably attached to container connector mechanisms 255, such that indicator flags 289 provide a visual cue indicating if the container connector mechanisms 255 are engaged (locked) or disengaged (unlocked) with the container connection points of the cargo container.

The operation of container connector mechanisms 255, drive linkage 265, gear box 260, arm 270, guides 287, actuator sling 275, and lift sling 280 to engage and/or disengage a cargo container are designed to meet industry standard (ISO) requirements and well known in the art and, thus, is not described in further detail here.

First frame portion 210 and second frame portion 215 may be connected directly to one another, or by extension beams 220 disposed lengthwise and spaced between ends of first frame portion 210 and second frame portion 215. In one example, an end of first side beam 230 and an end of second side beam 235 of first frame portion 210 are each connected to a respective end of first side beam 245 and second side beam 250 of second frame portion 215. The end of first side beam 230 and the end of second side beam 235 of first frame portion 210 may be connected to the respective ends of first side beam 245 and second side beam 250 of second frame portion 215, for example, by connector plates 290, or any other suitable mechanism. In one example, each of first side beam 230, first side beam 245, second side beam 235, and second side beam 250 have a corresponding connector plate 290 fixed at their ends, wherein connector plates 290 are capable of connecting with one another.

In another example, one or more extension beams 220 may be spaced lengthwise between an end of first side beam 230 of first frame portion 210 and an end of first side beam 245 of second frame portion 215, and one or more extension beams 220 may be spaced lengthwise between an end of second side beam 235 of first frame portion 210 and an end of second side beam 250 of second frame portion 215. Extension beams 220 may be connected to their respective ends of first side beam 230 of first frame portion 210 and first side beam 245 of second frame portion 215, and their respective ends of second side beam 235 of first frame portion 210 and second side beam 250 of second frame portion 215 by, for example, connector plates 290, or any other suitable mechanism. In one example, each of extension beams 220 have a connector plate 290 fixed at each of their ends, and each of first side beam 230, first side beam 245, second side beam 235, and second side beam 250 have a corresponding connector plate 290 fixed at their respective ends, wherein the connector plates 290 are capable of connecting with other corresponding connector plates 290. In yet another example, two or more extension beams 220 may be coupled together lengthwise to make a longer extension beam 220, and spaced and connected between respective ends of first frame portion 210 and second frame portion 215 to make a longer modular container lift spreader 200. Extension beams 220 may have a substantially rectangular, square, I, circular, or other suitably shaped cross section, and in one example, may be in the range of about 6 inches to about 8 inches in width and about 70 to about 80 inches in length.

Connector plates 290 may be permanently or removably fixed to the ends of first side beam 230, second side beam 235, first side beam 245, second side beam 250, and/or extension beams 220 using any suitable mechanism, including but not limited to, welding, nuts and bolts, clips, clamps, pins, or combination thereof. Corresponding connector plates 290 may be connected to one another using nuts and bolts, clips, clamps, pins, or any other suitable mechanism, or combination thereof, wherein the connector plates 290 are connected to one another in a non-permanent manner, thus allowing the modular container lift spreader 200 to be assembled and disassembled, in the field or for transport, into smaller modular components, e.g., first frame portion 210, second frame portion 215, extension beams 220, and/or drive linkage extensions 285; and also allows for customization based on size of modular container lift spreader 200 needed. For example, an extension beam 220 may be spaced lengthwise between each of the first side beams (230, 245) and second side beams (235, 250) of first frame portion 210 and second frame portion 215 to make, for example, a 20′ modular container lift spreader 200, or alternatively, two extension beams 220 may be coupled end to end and spaced lengthwise between each of the first side beams (230, 245) and second side beams (235, 250) of first frame portion 210 and second frame portion 215 to make, for example, a longer (e.g., 40′), modular container lift spreader 200.

In another embodiment, modular container lift spreader 200 may further include one or more frame extension sections 295 (shown in more detail in FIG. 5). The one or more frame extension sections 295 may include two parallel side beams 300 spaced apart by one or more cross support beams 257 and connected thereto. One or more cross support beams 257 may be permanently (welded or the like) or removably (bolts, pins, clamps, clips, or the like) attached to side beams 300. The one or more frame extension sections may further include connector plates 290 fixed at each of the ends of side beams 300. In one example, one or more frame extension sections 295, either alone or in combination with one or more extension beams 220, may be space lengthwise between first frame portion 210 and second frame portion 215 to assemble a modular container lift spreader 200 of differing sizes. Cross support beams 257 may also include a pass through 305 to allow drive linkage 265 or drive linkage extension 285 to pass through cross support beam 257. Connector plates 290 may be permanently or removably fixed to each of the ends of side beams 300 using any suitable mechanism, including but not limited to, welding, nuts and bolts, clips, clamps, pins, or combination thereof. Side beams 300 may have a substantially rectangular, square, I, circular, or other suitably shaped cross section, and may be in the range of about 6 inches to about 8 inches in width and about 70 to about 80 inches in length.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

The foregoing detailed description of embodiments refers to the accompanying drawings, which illustrate specific embodiments of the invention. The term “the invention” or the like is used with reference to certain specific examples of the many alternative aspects or embodiments of the applicant's invention set forth in this specification, and neither its use nor its absence is intended to limit the scope of the applicant's invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation, as the present invention is defined by the claims as set forth hereinafter.

That which is claimed:

1. A modular container lift spreader system, comprising:
a. a modular frame, comprising a first frame portion and a second frame portion;
b. extension beams configured to be disposed between ends of the first frame portion and the second frame portion, wherein the two or more extension beams are configured to connect the first frame portion to the second frame portion in a non-permanent manner; and
c. connector plates fixed to the ends of the first frame portion and second frame portion and ends of the two or more extension beams, wherein the connector plates are configured to connect to one another in a non-permanent manner.

2. The modular container lift spreader system of claim 1 wherein each of the first frame portion and second frame portion each comprise a first side beam and a second side beam attached to opposing end portions of a respective end beam.

3. The modular container lift spreader system of claim 2 wherein the first side beam of each of the first frame portion is substantially parallel relative to its respective second side beam, and wherein each of the first and second side beams are substantially perpendicular relative to their respective end beams.

4. The modular container lift spreader system of claim 2 wherein the first and second side beams are in a range of about 70 inches to about 80 inches in length.

5. The modular container lift spreader system of claim 1 wherein the two or more extension beams are in a range of about 70 inches to about 80 inches in length.

6. The modular container lift spreader system of claim 2 further comprising at least one cross beam disposed between each of the first and second side beams of the first frame portion and/or second frame portion.

7. The modular container lift spreader system of claim 6 wherein the at least one cross beam is substantially perpendicular relative to the first and second side beams of the first frame portion and/or second frame portion.

8. The modular container lift spreader system of claim 1 further comprising container connector mechanisms disposed at each corner of the modular frame for engaging connection fittings of a container to be moved.

9. The modular container lift spreader system of claim 8 wherein the container connector mechanisms comprise twist lock bayonets.

10. The modular container lift spreader system of claim 8 further comprising a gear box and a drive linkage, wherein the gear box is operably connected to the container connector mechanisms by the drive linkage.

11. The modular container lift spreader system of claim 10 wherein the gear box is mounted to a cross beam disposed between a first side beam and a second side beam of one of the first frame portion or second frame portion.

12. The modular container lift spreader system of claim 10 wherein the gear box and drive linkage are configured to simultaneously actuate all the container connector mechanisms between a locked and unlocked position.

13. The modular container lift spreader system of claim 10 further comprising one or more drive linkage extensions, wherein the drive linkage extensions are configured to operably attach to an end of a drive linkage and/or between two drive linkages to extend the length of the drive linkage.

14. The modular container lift spreader system of claim 10 wherein the gear box comprises a lift arm, wherein the lift arm is configured to drive the gear box.

15. The modular container lift spreader system of claim 14 wherein the lift arm is operably connected to an actuator sling, wherein the actuator sling is configured such that lowering and raising of the actuator sling actuates the arm of the gear box to simultaneously operate the container connector mechanisms between locked and unlocked positions.

16. The modular container lift spreader system of claim 15 wherein the actuator sling is further operably attached to a lift sling, wherein the lift sling comprises one or more cables for attaching the modular frame to a lifting mechanism.

17. The modular container lift spreader system of claim 1 wherein the extension beams comprise one or more frame extension sections, and wherein the one or more frame extension sections comprise at least two parallel side beams spaced apart from one another by one or more cross support beams.

18. Method of assembling a modular container lift spreader, the method comprising:
a. providing a modular container lift spreader system, comprising:
i. a modular frame, comprising a first frame portion and a second frame portion;
ii. extension beams configured to be disposed between ends of the first frame portion and the second frame portion, wherein the two or more extension beams are configured to connect the first frame portion to the second frame portion in a non-permanent manner; and
iii. connector plates fixed to the ends of the first frame portion and second frame portion and ends of the two or more extension beams, wherein the connector plates are configured to connect to one another in a non-permanent manner; and
b. connecting extension beams between ends of the first frame portion and the second frame portion via the connector plates to achieve a desired length of the modular container lift spreader.

19. The method of claim 18 wherein the modular container lift spreader system further comprises a gear box and a drive linkage, wherein the gear box is operably connected to container connector mechanisms by the drive linkage, and wherein the container connector mechanisms are configured for engaging connection fittings of a container to be moved.

20. The method of claim 19 further comprising connecting one or more drive linkage extensions to the drive linkage based on the desired length of the modular container lift spreader, and wherein the drive linkage extensions are configured to operably attach to an end of a drive linkage and/or between two drive linkages to extend the length thereof.

21. The method of claim 18 wherein the extension beams comprise one or more frame extension sections, and wherein the one or more frame extension sections comprise at least two parallel side beams spaced apart from one another by one or more cross support beams.
